(19) United States
(12) Patent Application Publication
(10) Pub. No.: US 2011/0065010 A1
(43) Pub. Date: Mar. 17, 2011

(54) Fuel Reformer Integration With Carbon Dioxide Scrubbers

(76) Inventors: A. Alan Burke, North Kingstown, RI (US); Louis G. Carreiro, Westport, MA (US)

(21) Appl. No.: 12/560,786

(22) Filed: Sep. 16, 2009

(51) Int. Cl. H01M 8/18

(52) U.S. Cl. 429/410; 429/420

(57) ABSTRACT

The invention as disclosed is the integration of a fuel reformer reactor and a carbon dioxide scrubbing reactor for use in high temperature fuel cells. The reformer is placed in series with and between two carbon dioxide scrubbers. Fuel gas from the fuel cell is passed through a first carbon dioxide scrubber where the fuel gas is heated, has carbon dioxide gas removed there from, and is passed to the reformer. The gas exiting the reformer is scrubbed and heated by the second carbon dioxide scrubber before the gas is supplied to the fuel cell.

### STATEMENT OF GOVERNMENT INTEREST

The invention described herein may be manufactured and used by or for the Government of the United States of America for governmental purposes without the payment of any royalties thereon or therefore.

### CROSS REFERENCE TO OTHER PATENT APPLICATIONS

None.

### BACKGROUND OF THE INVENTION

(1) Field of the Invention

The present invention is directed to fuel reformers. In particular, the present invention is directed to an integration of a fuel reformer reactor and multiple carbon dioxide scrubbing reactors that can be used to convert hydrocarbon fuels into hydrogen rich reformate streams while also sequestering carbon dioxide gas.

(2) Description of the Prior Art

For a fuel cell system in which the anode exhaust (fuel gas) is recycled back into the fuel reformer, there exist the dual problems of managing carbon dioxide gas and providing heat to the fuel reformer. Adding a carbon dioxide scrubber into the balance of plant can alleviate both of these issues by providing heat to the fuel reformer via the exothermic removal of carbon dioxide when it reacts with lime (CaO). This reaction is illustrated in reaction equation (1):

CO_{2(g)}+CaO₍ₛ₎→CaCO₃₍ₛ₎+HEAT (1)

This method allows for steam reforming to occur in the fuel reformer instead of auto-thermal reformation (ATR) or catalytic partial oxidation (CPOX). Steam reforming is advantageous because it offers higher energy content in the product gas than either ATR or CPOX. However, steam reforming is often not selected because it is an endothermic process and requires substantial heat for sustained operation. There are many examples of solid oxide fuel cell (SOFC) stacks being tested with ATR or CPOX systems, whereas steam reforming is less common.

Once a carbon dioxide scrubber becomes ineffective (deactivates), the lime must be regenerated to reactivate the scrubber. Carbon dioxide scrubbing takes place at an appreciable rate in the temperature range of 500-700° C. At temperatures above 800° C., lime regeneration (calcination) proceeds by the reverse of reaction equation (1) and with the release of carbon dioxide. The exact temperature at which this reaction occurs depends upon the partial pressures of steam and carbon dioxide present in the gas stream. In general, it is anticipated that a scrubber will operate in the 450-750° C. temperature range while it will regenerate in the 700-900° C. temperature range.

A key requirement for a fuel cell powered unmanned undersea vehicle operating in shallow water is the reduction or elimination of the evolution of product gases. Carbon dioxide is produced from the use of hydrocarbons and must be contained and stored on board the vehicle. For this reason, a high temperature fuel cell combined with a fuel reformer system that uses multiple carbon dioxide scrubbers offers an innovative solution to address carbon dioxide containment while also obtaining high system efficiency. What is needed is a fuel cell system that employs one or more fuel reformers with multiple carbon dioxide scrubbers that function in parallel so that a fuel cell can maintain operation with an active carbon dioxide scrubber and reformer system while an inactive carbon dioxide scrubber is regenerated, thereby managing carbon dioxide gas and providing heat to the fuel reformer.

### SUMMARY OF THE INVENTION

It is a general purpose and object of the present invention to provide heat to a fuel reformer reactor from a carbon dioxide scrubber reactor for use in a high temperature fuel cell.

It is a further object to remove carbon dioxide gas from the fuel stream of a high temperature fuel cell in which the anode gas is recycled back into a fuel reformer.

It is a further object to provide heat to the reformer exhaust gases so that the reformate gas entering the fuel cell is of appropriate temperature.

The above objects are accomplished with the present invention through the use of the integration of a fuel reformer reactor and a carbon dioxide scrubbing reactor. The reformer is placed in series with and between two carbon dioxide scrubbers. Fuel gas from the fuel cell is passed through a first carbon dioxide scrubber where the fuel gas is heated, has carbon dioxide gas removed there from, and is passed to the reformer. The gas exiting the reformer is scrubbed and heated by the second carbon dioxide scrubber before the gas is supplied to the fuel cell.

### BRIEF DESCRIPTION OF THE DRAWINGS

A more complete understanding of the invention and many of the attendant advantages thereto will be more readily appreciated by referring to the following detailed description when considered in conjunction with the accompanying drawings, wherein like reference numerals refer to like parts and wherein:

FIG. 1 illustrates a flow diagram of the present invention including a fuel reformer and a first and second stage carbon dioxide scrubber as implemented with a high temperature fuel cell;

### DETAILED DESCRIPTION OF THE INVENTION

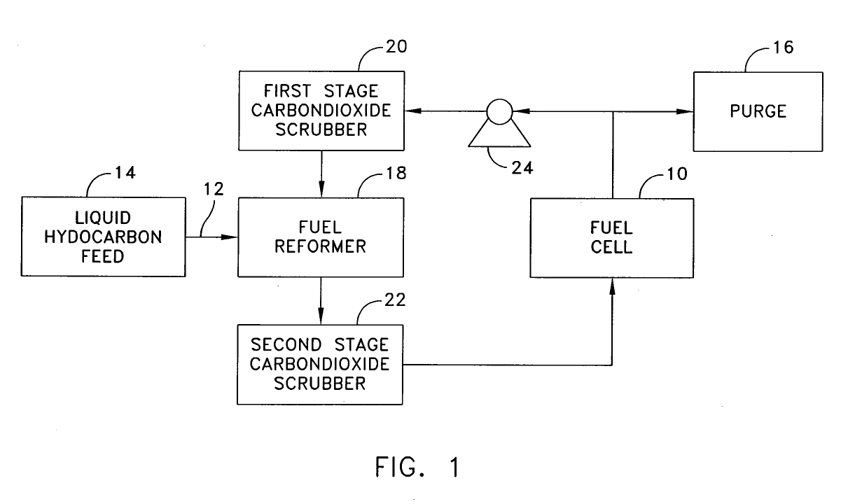

Referring to FIG. 1 there is illustrated a flow diagram of the present invention as implemented with a high temperature fuel cell 10 such as a solid oxide fuel cell. Specifically, FIG. 1 illustrates the flow of the anode gas 12 through its various incarnations from its origination at the liquid hydrocarbon feed 14 to its use in the fuel cell 10 and as it is channeled back into the reforming process for recycling. Beginning at the fuel cell 10, the anode gas 12 exits the fuel cell 10 as an exhaust gas after being partially oxidized in the fuel cell 10. A purge 16 is available when needed to prevent over-pressurization and/or to remove diluents. The anode gas 12 is directed to a recycle pump 24. The anode gas 12 then passes through the first stage carbon dioxide scrubber 20. The first stage carbon dioxide scrubber 20 will remove the carbon dioxide and elevate the temperature of the gas before it enters the fuel reformer 18 to mix with the fresh liquid hydrocarbon that is fed from the liquid hydrocarbon feed 14. In a preferred embodiment, fuel reformer 18 is a steam reformer. The heat from the anode gas 12 as it exits the first stage carbon dioxide scrubber 20 will be used to drive and sustain the operation of the fuel reformer 18. The anode gas 12 exiting the fuel reformer 18 as reformer effluent gas will then pass through the second stage carbon dioxide scrubber 22. The second stage carbon dioxide scrubber 22 will remove carbon dioxide and heat the anode gas 12 such that when the anode gas 12 exits the second stage carbon dioxide scrubber 22 as scrubbed reformate effluent gas it is heated to the appropriate inlet temperature that the fuel cell 10 requires. It is possible that there may be extra heat generated from the second stage carbon dioxide scrubber 22, and this heat can either be directed back into the fuel reformer 18 by means of a heat exchanger or dissipated to the surroundings if it is not needed.

This invention is an integrated fuel processor system with two distinct features: (1) it generates its own heat to sustain fuel reformer operation and (2) it uses calcium oxide to react with carbon dioxide gas to form a storable solid calcium carbonate. The reformer 18 is placed in series between the two scrubbers 20, 22 to heat the recycled exhaust gas from the fuel cell 10 in the first stage carbon dioxide scrubber 20 and use this heat to drive the reforming process, and to heat the reformer effluent gas in the second stage scrubber 22 so that the reformate gas entering the fuel cell 10 is of an appropriate temperature. Another key aspect of this system is that the anode gas 12 stream has the opportunity to be generated without air, thus nitrogen does not dilute the gas stream. Once the system is at operating temperature, it should remain self-sustaining as long as the scrubber bed is active and the fuel cell 10 is operating at the desired power range. Under those conditions, this invention allows for sustained operation of a fuel cell 10 system as long as the carbon dioxide scrubbers 20, 22 remain active.

The advantage of the present invention is that it minimizes the release of gaseous carbon dioxide, avoids large temperature swings in the anode flow path and allows for more efficient fuel reformer operation, thus resulting in higher system efficiencies and cleaner energy production.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

What is claimed is:

1. An apparatus converting hydrocarbon fuels into hydrogen rich reformate streams while also sequestering carbon dioxide gas for use with a high temperature fuel cell comprising:
a liquid hydrocarbon feed that contains a liquid hydrocarbon fuel;
a fuel reformer joined to said liquid hydrocarbon feed wherein said fuel reformer receives the liquid hydrocarbon fuel from said liquid hydrocarbon feed and reforms it into a reformer effluent gas;
a first carbon dioxide scrubber joined to said fuel reformer that receives the reformer effluent gas and removes carbon dioxide from the reformer effluent gas and heats the reformer effluent gas thereby producing a scrubbed reformate effluent gas that is heated to a predetermined temperature range;
a high temperature fuel cell joined to said first carbon dioxide scrubber that receives the scrubbed reformate effluent gas that serves as a fuel to power the fuel cell, wherein said high temperature fuel cell partially oxidizes the scrubbed reformate effluent gas into a fuel cell exhaust gas;
a recycle pump that receives said fuel cell exhaust gas from the high temperature fuel cell for the purpose of recycling the fuel cell exhaust gas; and
a second carbon dioxide scrubber joined to said recycle pump and to said fuel reformer that receives the fuel cell exhaust gas from the recycle pump and removes carbon dioxide from the fuel cell exhaust gas and heats the fuel cell exhaust gas before channeling it to the fuel reformer wherein the scrubbed and heated fuel cell exhaust gas is mixed with the liquid hydrocarbon fuel, wherein the heat from the scrubbed and heated fuel cell exhaust gas drives and sustains the operation of the fuel reformer.

2. The apparatus of claim 1 wherein the high temperature fuel cell is a solid oxide fuel cell.

3. The apparatus of claim 1 wherein the fuel reformer is a steam fuel reformer.

4. The apparatus of claim 1 further comprising a purge joined to the high temperature fuel cell, wherein said purge is available to prevent over-pressurization and to remove diluents.
